(19) United States
(12) Patent Application Publication
(10) Pub. No.: US 2026/0206733 A1
(43) Pub. Date: Jul. 23, 2026

(54) REPLACEMENT FISHING EYES

(71) Applicant: SHAWN LEE DYKES, BOONEVILLE, AR (US)

(72) Inventor: SHAWN L DYKES, BOONEVILLE, AR (US)

(73) Assignee: SHAWN LEE DYKES, BOONEVILLE, AR (US)

(21) Appl. No.: 19/238,490

(22) Filed: Jun. 15, 2025

Related U.S. Application Data
(60) Provisional application No. 63/833,321, filed on Nov. 18, 2024.

(51) Int. Cl. A01K 87/04

(52) U.S. Cl. CPC A01K 87/04

(57) ABSTRACT

An eyelet system for a fishing rod includes first and second eyelet assemblies. The first eyelet assembly includes first and second base components movable between first open and closed positions with respect to each other. In the first closed position, the first eyelet assembly is removably coupled to a distal section of the fishing rod. In the first open position, the first eyelet assembly is separated from the distal section to be replaceable with another first eyelet assembly. The second eyelet assembly includes third and fourth base components movable between second open and closed positions with respect to each other. In the second closed position, the second eyelet assembly is removably coupled to a proximal section of the fishing rod. In the second open position, the second eyelet assembly is separated from the proximal section of the fishing rod to be replaceable with another second eyelet assembly.

### CROSS-REFERENCE TO RELATED APPLICATIONS

This application claims the benefit of U.S. Provisional Ser. No. 63/833,321, filed Nov. 18, 2024, the disclosure of which is hereby incorporated herein by reference in its entirety.

### TECHNICAL FIELD

The present disclosure relates generally to a fishing rod assembly, and, more particularly, to eyelet assemblies couplable to the fishing rod in a spaced and replaceable manner.

### BACKGROUND

Fishing rods are tools generally used by anglers. Fishing rods typically include eyelets or guides that are positioned along a length of the fishing rod and are applied to guide and direct a fishing line from a fishing reel to the fishing rod's tip. Such guides are susceptible to damage due to their repetitive use and exposure to the environment. It is common for guides to experience wear, corrosion, and the like conditions, in turn affecting their performance and usability. In some environments, such as remote locations and extreme wilderness, anglers may lack extra fishing rod assemblies and a damage to any one or more of the guides can make survival in such locations a challenge. Moreover, guide repairs are often impractical in such environments.

### SUMMARY

In one aspect of the disclosure, an eyelet system for a fishing rod of a fishing rod assembly is described. The eyelet system includes a first eyelet assembly including a first base component and a second base component movable between a first open position and a first closed position with respect to each other. In the first closed position, the first eyelet assembly is adapted to enwrap and be removably coupled to a distal section of the fishing rod. In the first open position, the first eyelet assembly is adapted to be separated from the distal section of the fishing rod to be replaceable with another first eyelet assembly. Further, the eyelet system includes a second eyelet assembly including a third base component and a fourth base component movable between a second open position and a second closed position with respect to each other. In the second closed position, the second eyelet assembly is adapted to enwrap and be removably coupled to a proximal section of the fishing rod. In the second open position, the second eyelet assembly is adapted to be separated from the proximal section of the fishing rod to be replaceable with another second eyelet assembly.

In some additional, alternative, or selectively cumulative embodiments, the distal section defines an end of the fishing rod, and the first eyelet assembly is configured to be positioned to cover said end of the fishing rod and define an end tip of the fishing rod assembly.

In some additional, alternative, or selectively cumulative embodiments, the first base component and the second base component are tubular in structure and define a first tubular channel in the first closed position. The first tubular channel is defined around and along a rod axis of the fishing rod to allow a first portion of the fishing rod to be accommodated therethrough.

In some additional, alternative, or selectively cumulative embodiments, the first tubular channel defines a tube axis configured to be aligned with the rod axis when the first eyelet assembly enwraps the distal section. The first eyelet assembly includes a conical segment with an apex defining an end tip of the fishing rod assembly. The conical segment defines a segment channel with a segment axis. Also, the segment axis is in line with the tube axis.

In some additional, alternative, or selectively cumulative embodiments, the first eyelet assembly further includes a first eye piece defining a first ring structure with a first opening to provide passage to the fishing reel and a first strip structure extending away from the first ring structure. The first strip structure is configured to be received within the segment channel of the conical segment.

In some additional, alternative, or selectively cumulative embodiments, a first inner surface of the conical segment defining the segment channel defines first retentive features and the first strip structure defines first engagement features to establish a retentive coupling between the first eye piece and the conical segment when the first strip structure is received within the segment channel.

In some additional, alternative, or selectively cumulative embodiments, the conical segment is integrally formed with the first base component.

In some additional, alternative, or selectively cumulative embodiments, the first base component and the second base component are coupled to each other at a first hinge defining a first swivel axis such that the first base component and the second base component swivel with respect to each other about the first swivel axis when moving between the first open position and the first closed position.

In some additional, alternative, or selectively cumulative embodiments, the first swivel axis is parallel to a rod axis of the fishing rod.

In some additional, alternative, or selectively cumulative embodiments, the first base component and the second base component correspondingly define first teeth and second teeth to correspondingly engage with the distal section of the fishing rod.

In some additional, alternative, or selectively cumulative embodiments, the third base component and the fourth first base component are tubular in structure and define a second tubular channel in the second closed position. The second tubular channel is defined around and along a rod axis of the fishing rod to allow a second portion of the fishing rod to be accommodated therethrough.

In some additional, alternative, or selectively cumulative embodiments, the third base component and the fourth base component are coupled to each other at a second hinge defining a second swivel axis such that the third base component and the fourth base component swivel with respect to each other about the second swivel axis when moving between the second open position and the second closed position.

In some additional, alternative, or selectively cumulative embodiments, the second swivel axis is parallel to a rod axis of the fishing rod.

In some additional, alternative, or selectively cumulative embodiments, the third base component and the fourth base component correspondingly define third teeth and fourth teeth to correspondingly engage with the proximal section of the fishing rod.

In some additional, alternative, or selectively cumulative embodiments, the third base component and the fourth base component, either alone or in combination, defines a component channel. The second eyelet assembly further includes a second eye piece defining a second ring structure with a second opening to provide passage to the fishing reel and a second strip structure extending away from the second ring structure. The second strip structure is configured to be received within the component channel. A second inner surface of at least one of the third base component and the fourth base component, defining the component channel, also defines second retentive features. The second strip structure defines second engagement features to establish a retentive coupling between the second eye piece and at least one of the third base component and the fourth base component when the second strip structure is received within the component channel.

In another aspect of the present description, a fishing rod assembly is described. The fishing rod assembly includes a fishing rod, a fishing reel configured to wind and release a fishing line, a plurality of eyelet assemblies couplable with the fishing rod in a spaced manner along a length of the fishing rod. Each eyelet assembly of the plurality of eyelet assemblies is configured to receive and guide the fishing line extending from the fishing reel. Also, each eyelet assembly includes a pair of base components adapted to be selectively movable between an open position and a closed position with respect to each other. In the closed position, each eyelet assembly enwraps and is coupled to a corresponding section of the fishing rod, and, in the open position, each eyelet assembly is configured to be separated from the corresponding section of the fishing rod to be replaceable with another eyelet assembly.

In some additional, alternative, or selectively cumulative embodiments, each base component of the pair of base components is at least partially tubular in structure. The pair of base components defines a tubular channel in the closed position. The tubular channel is defined around and along a rod axis of the fishing rod to allow a portion of the fishing rod to be accommodated therethrough.

In some additional, alternative, or selectively cumulative embodiments, each eyelet assembly includes an eye piece defining a ring structure with an opening to provide passage to the fishing reel and a strip structure extending away from the ring structure. The strip structure is configured to be received within a segment channel defined by at least one base component of the pair of base components.

In some additional, alternative, or selectively cumulative embodiments. The pair of base components are coupled to each other at a hinge defining a swivel axis such that the pair of base components swivel with respect to each other about the swivel axis when moving between the open position and the closed position. The swivel axis is parallel to a rod axis of the fishing rod.

In some additional, alternative, or selectively cumulative embodiments, each base component of the pair of base components define teeth to engage with the corresponding section of the fishing rod.

### BRIEF DESCRIPTION OF THE DRAWINGS

FIG. 1 is an exemplary view of a fishing rod assembly having a first eyelet assembly and a second eyelet assembly, in accordance with an embodiment of the disclosure;

FIG. 2 is an assembled view of the first eyelet assembly for a fishing rod of the fishing rod assembly, in accordance with an embodiment of the disclosure;

FIG. 3 is an exploded view of the first eyelet assembly, in accordance with an embodiment of the disclosure;

FIG. 4 is an exemplary cross-sectional view of a first base component of the first eyelet assembly, in accordance with an embodiment of the disclosure;

FIG. 5 is an exemplary plan view of a second base component of the first eyelet assembly, in accordance with an embodiment of the disclosure;

FIG. 6 a perspective view of a first eye piece of the first eyelet assembly, in accordance with an embodiment of the disclosure;

FIG. 7 is an assembled view of the second eyelet assembly for the fishing rod of the fishing rod assembly, in accordance with an embodiment of the disclosure;

FIG. 8 is an exploded view of the second eyelet assembly, in accordance with an embodiment of the disclosure;

FIG. 9 is a perspective view of a third base component of the second eyelet assembly, in accordance with an embodiment of the disclosure; and

FIG. 10 is a perspective view of a fourth base component of the second eyelet assembly, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

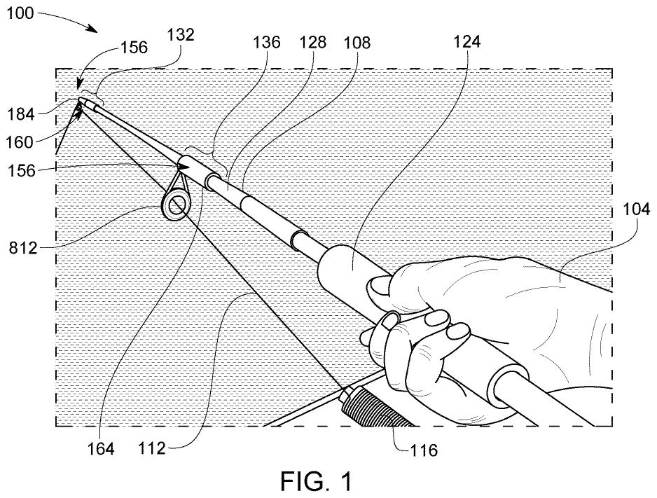

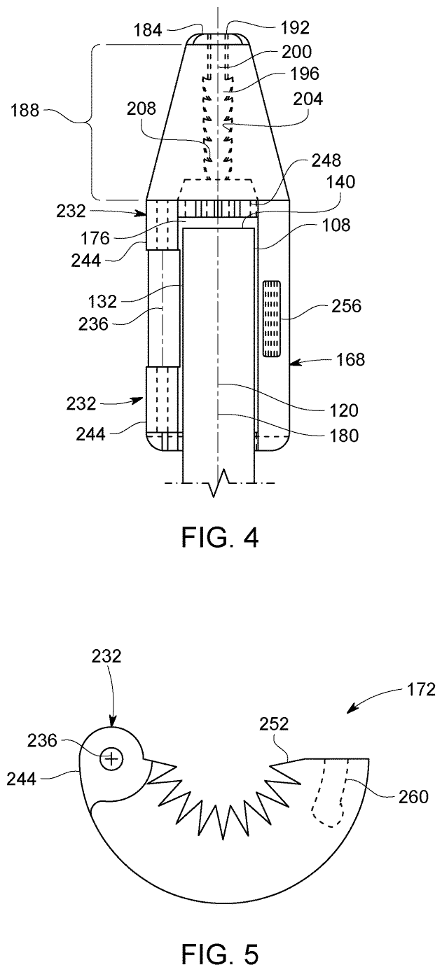

Referring to FIGS. 1 and 4, a fishing rod assembly 100 is described. The fishing rod assembly 100 is useable by an angler 104, and the like personnel, for recreational activities, sporting events, and/or for general or commercial fishing applications. The fishing rod assembly 100 includes a fishing rod 108, a fishing line 112, and a fishing reel 116, as shown in FIG. 1. The fishing reel 116 may be mounted to the fishing rod 108 and is configured to wind and release the fishing line 112 with respect to the fishing rod 108 as and when needed. To this end, the fishing reel 116 may include a spool configured to support the fishing line 112 wound thereon and be usable to retrieve and wind the fishing line 112 onto the spool. Effectively, the fishing reel 116 is configured to support a casting of the fishing line 112, a retrieval of the fishing line 112 after casting, and a controlled handling of tension applied to the fishing line 112, during use. Such details are well known to those in the art and thus need not be further described.

The fishing rod 108 includes an elongate member, e.g., a cylindrically shaped elongate member, defining a rod axis 120 (see FIG. 4). The fishing rod 108 includes a handle 124 onto which or relatively adjacent to which the fishing reel 116 may be mounted, although other locations for the fishing reel 116 on the fishing rod 108 may be contemplated by someone in the art based on the present disclosure. Further, the fishing rod 108 includes a body 128 (e.g., a longitudinal body as shown in FIG. 1) that extends away from the handle 124. Both the handle 124 and the body 128 may be defined about the rod axis 120 to extend along the rod axis 120. The body 128 may define a distal section 132 of the fishing rod 108 and a proximal section 136 of the fishing rod 108. In some embodiments, the distal section 132 defines an end 140 (see FIG. 4) of the fishing rod 108 remote to the handle 124 and to the proximal section 136. According to an example, the fishing line 112 extends from the spool along the length of the fishing rod 108 and outwardly away from the end 140 of the fishing rod 108 for the casting and retrieval operations.

The fishing rod assembly 100 includes an eyelet system 156 (see FIGS. 1, 2, and 7) including a number of eyelet assemblies, namely, a first eyelet assembly 160 and a second eyelet assembly 164, as shown. The first eyelet assembly 160 and the second eyelet assembly 164 are couplable with the fishing rod 108 in a spaced manner along a length of the fishing rod 108. Moreover, each eyelet assembly is configured to receive and guide the fishing line 112 extending from the fishing reel 116.

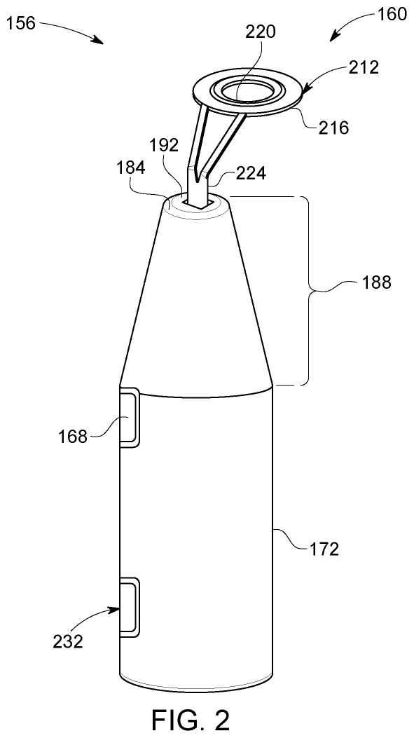

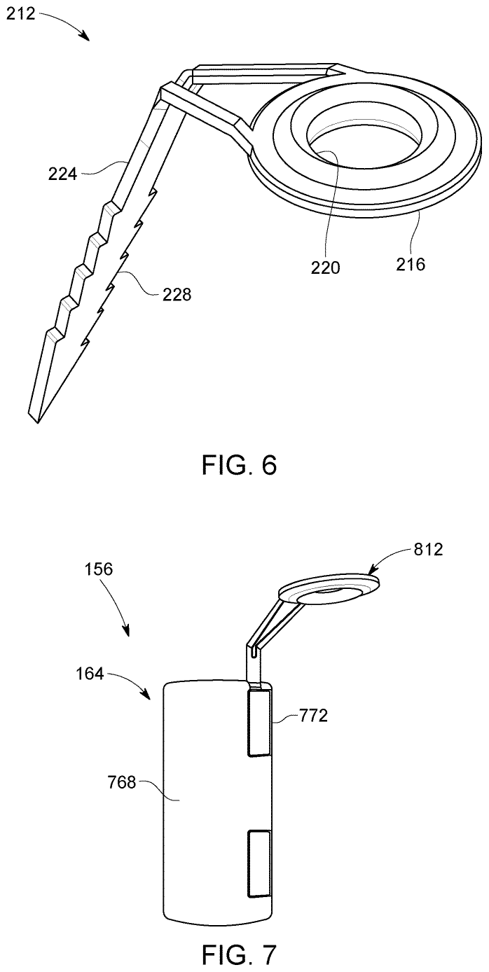

Referring to FIG. 2 through 6, the first eyelet assembly 160 is adapted to be mounted to the end 140 of the fishing rod 108 and includes a first base component 168 and a second base component 172. The first base component 168 and the second base component 172 are movable between a first open position and a first closed position with respect to each other. In the first closed position, the first eyelet assembly 160 is adapted to enwrap and be removably coupled to the distal section 132 of the fishing rod 108. In the first open position, the first eyelet assembly 160 is adapted to be separated from the distal section 132 of the fishing rod 108 to be replaceable with another first eyelet assembly (not shown, but which may be similar to the first eyelet assembly 160).

In some embodiments, the first base component 168 and the second base component 172 are tubular in structure and define a first tubular channel 176 in the first closed position. For example, the first base component 168 defines a first half of a tubular or a cylindrical structure and the second base component 172 defines a second half of the tubular or the cylindrical structure. Each half may define corresponding hollows (e.g., cylindrically shaped hollows) such that when the first base component 168 and the second base component 172 are brought together in the first closed position, they define the first tubular channel 176 in concert. The first tubular channel 176 is defined around and along the rod axis 120 of the fishing rod 108 to allow a first portion (e.g., the distal section 132 with the end 140) of the fishing rod 108 to be accommodated therethrough. According to some embodiments, the first tubular channel 176 defines a first tube axis 180 configured to be aligned with the rod axis 120 when the first eyelet assembly 160 enwraps the distal section 132.

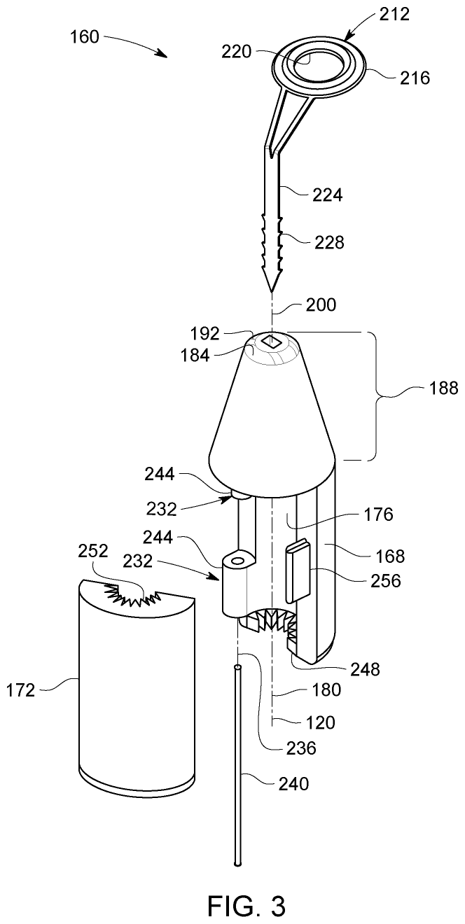

The first eyelet assembly 160 is configured to be positioned to cover the end 140 of the fishing rod 108 and define an end tip 184 of the fishing rod assembly 100. In this regard, the first eyelet assembly 160 also includes a conical segment 188. The conical segment 188 may be located adjacent to or positioned over one of the axial ends of the cylindrical structure formed when the first base component 168 and the second base component 172 are moved to the first closed position. In some embodiments, the conical segment 188 may be integral (e.g., integrally formed) with one of the base components, e.g., the first base component 168, as shown in FIG. 3. As an example, the conical segment 188 may define an apex 192, that in turn also defines the end tip 184 of the fishing rod assembly 100 when the first eyelet assembly 160 is coupled to cover the distal section 132 and/or the end 140 of the fishing rod 108. As shown in FIG. 4, the apex 192 may be spaced away (e.g., axially spaced away) from the first base component 168 and the second base component 172 and also from the end 140 of the fishing rod 108.

The conical segment 188 may further define a segment channel 196 (see FIG. 4) with a segment axis 200. In some embodiments, the segment axis 200 is in line with the first tube axis 180 when the first eyelet assembly 160 is coupled to the fishing rod 108 at the distal section 132 or over the end 140 of the fishing rod 108. Although not limited, such coupling also allows the segment channel 196 and the first tubular channel 176 to be aligned to each other as well. Further, a first inner surface 204 of the conical segment 188 defining the segment channel 196 defines first retentive features 208, as shown in FIG. 4. In some embodiments, the first inner surface 204 and the end 140 of the distal section 132 may include complementary threads (not shown) such that the first eyelet assembly 160 may be threadably coupled to the distal section 132.

The first eyelet assembly 160 further includes a first eye piece 212 as shown in FIGS. 2 and 3. The first eye piece 212 defines a first ring structure 216 with a first opening 220 to provide passage to the fishing line 112. Further, the first eye piece 212 defines a first strip structure 224 extending away from the first ring structure 216. Although not limited, the first opening 220 can include a circular or an oval shape. As shown in FIGS. 2 and 3, the first strip structure 224 is configured to be received within the segment channel 196 of the conical segment 188. In this regard, the first strip structure 224 defines first engagement features 228 to establish a retentive coupling between the first eye piece 212 and the conical segment 188 when the first strip structure 224 is received within the segment channel 196 and the first engagement features 228 are engaged with the first retentive features 208. In some embodiments, one or both of the first retentive features 208 and the first engagement features 228 are formed from a resilient material, e.g., rubber, to provide sufficient compressive deformation therebetween and also acquire a positive interference fit therebetween. In some embodiments, the first ring structure 216 can be made from a smooth, a low-friction, or a friction free material such as ceramic, stainless steel, or titanium, to minimize wear on the fishing line 112.

Also, the first base component 168 and the second base component 172 may be coupled to each other at a first hinge 232 defining a first swivel axis 236. In so doing, the first base component 168 and the second base component 172 swivel with respect to each other about the first swivel axis 236 when moving between the first open position and the first closed position. To this end, the first eyelet assembly 160 may include a first pin 240 (see FIG. 3) as part of the first hinge 232, and the first base component 168 and the second base component 172 may define suitable protrusions 244 (which may form parts of the first hinge 232) through which the first pin 240 may be extended and/or rotatably coupled to. The first swivel axis 236 may pass through the first pin 240 such that the first base component 168 and the second base component 172 may swivel or articulate about the first pin 240. Although not limited, in some embodiments, the first swivel axis 236 is parallel to the rod axis 120 of the fishing rod 108.

In some embodiments, the first base component 168 and the second base component 172 correspondingly define first teeth 248 and second teeth 252 to correspondingly engage with the distal section 132 of the fishing rod 108 when the first base component 168 and the second base component 172 (or the first eyelet assembly 160) are moved to the first closed position. As an example, the engagement offered by the first teeth 248 and the second teeth 252 with the distal section 132 of the fishing rod 108 enables the first eyelet assembly 160 to be coupled to the fishing rod 108 with an interference fit. As a result, the first eyelet assembly 160 can be immovably coupled to the distal section 132 of the fishing rod 108. In other words, the first teeth 248 and second teeth 252 bite through distal section 132 providing stability, and, at the same time, also preventing any movement of the first eyelet assembly 160 with respect to the distal section 132 of the fishing rod 108. Said coupling of the first eyelet assembly 160 to the fishing rod 108 is removable since the first base component 168 and the second base component 172 may be selectively moved to the first open position (e.g., from the first closed position). The first teeth 248 and the second teeth 252 may be made from resilient materials, such as rubber, polymer, and the like, to enable an adjustable (but tight fit) clamping between the first eyelet assembly 160 and varying sized distal sections or ends of fishing rods, such as the fishing rod 108. Also, a size and a design of one or more of: the first base component 168, second base component 172, first teeth 248, and second teeth 252, can vary such that the first eyelet assembly 160 can be easily usable and mountable to multiple fishing rods having a variety of shapes and sizes and diameters.

Referring to FIGS. 3 through 5, the first base component 168 may define a tab 256 (see FIG. 3) and the second base component 172 may define a receptacle 260 (see FIG. 5). In the first closed position, the tab 256 may be received within the receptacle 260 (e.g., snapped into the receptacle 260) such that the first base component 168 and the second base component 172 can be retentively coupled to each other, and, such that, the first base component 168 and the second base component 172 may be coupled together to the distal section 132 and/or to the end 140 of the fishing rod 108.

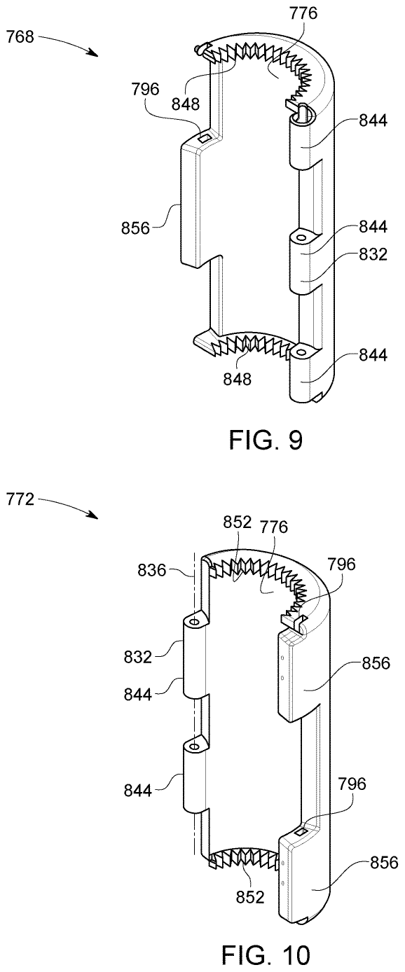

Referring to FIGS. 7 through 10, the second eyelet assembly 164 is described. The second eyelet assembly 164 is adapted to be mounted to the proximal section 136 of the fishing rod 108 and includes a third base component 768 and a fourth base component 772. The third base component 768 and the fourth base component 772 are movable between a second open position and a second closed position with respect to each other. In the second closed position, the second eyelet assembly 164 is adapted to enwrap and be removably coupled to the proximal section 136 of the fishing rod 108. In the second open position, the second eyelet assembly 164 is adapted to be separated from the proximal section 136 of the fishing rod 108 to be replaceable with another second eyelet assembly (not shown, but which may be similar to the second eyelet assembly 164).

In some embodiments, the third base component 768 and the fourth base component 772 are tubular in structure and define a second tubular channel 776 in the second closed position. For example, the third base component 768 defines a first half of a tubular or a cylindrical structure and the fourth base component 772 defines a second half of the tubular or the cylindrical structure. Each half may define corresponding hollows (e.g., cylindrically shaped hollows) such that when the third base component 768 and the fourth base component 772 are brought together in the second closed position, they define the second tubular channel 776 in concert. The second tubular channel 776 is defined around and along the rod axis 120 of the fishing rod 108 to allow a second portion (e.g., the proximal section 136) of the fishing rod 108 to be accommodated therethrough. According to some embodiments, the second tubular channel 776 defines a second tube axis 780 configured to be aligned with the rod axis 120 when the second eyelet assembly 164 enwraps the proximal section 136.

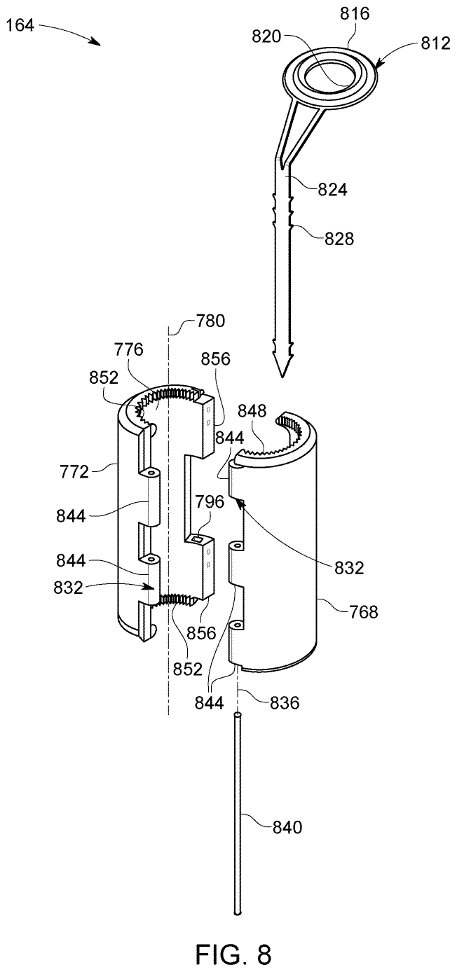

Also, the third base component 768 and the fourth base component 772 may be coupled to each other at a second hinge 832 defining a second swivel axis 836 (see FIG. 8). In so doing, the third base component 768 and the fourth base component 772 swivel with respect to each other about the second swivel axis 836 when moving between the second open position and the second closed position. To this end, the second eyelet assembly 164 may include a second pin 840 (see FIG. 8) as part of the second hinge 832, and the third base component 768 and the fourth base component 772 may respectively define suitable protrusions 844 (which may form parts of the second hinge 832) through which the second pin 840 may be extended and/or rotatably coupled to. The second swivel axis 836 may pass through the second pin 840 such that the third base component 768 and the fourth base component 772 may swivel or articulate about the second pin 840. In some embodiments, the second swivel axis 836 is parallel to the rod axis 120 of the fishing rod 108.

In some embodiments, the third base component 768 and the fourth base component 772 correspondingly define third teeth 848 and fourth teeth 852 to correspondingly engage with the proximal section 136 of the fishing rod 108 when the third base component 768 and the fourth base component 772 (or the second eyelet assembly 164) are moved to the second closed position. As an example, the engagement offered by the third teeth 848 and the fourth teeth 852 with the proximal section 136 of the fishing rod 108 enables the second eyelet assembly 164 to be coupled to the fishing rod 108 with an interference fit. As a result, the second eyelet assembly 164 can be immovably coupled to the proximal section 136 of the fishing rod 108. In other words, the third teeth 848 and fourth teeth 852 bite through proximal section 136, providing stability, and, at the same time, also preventing any movement of the second eyelet assembly 164 with respect to the proximal section 136 of the fishing rod 108. Said coupling of the second eyelet assembly 164 to the fishing rod 108 is removable since the third base component 768 and the fourth base component 772 may be selectively moved to the second open position (e.g., from the second closed position). The third teeth 848 and the fourth teeth 852 may be made from resilient materials, such as rubber, polymer, and the like, to enable an adjustable (but tight fit) clamping between the second eyelet assembly 164 and varying sized proximal sections of fishing rods. Also, a size and a design of one or more of: the third base component 768, fourth base component 772, third teeth 848, and fourth teeth 852, can vary such that the second eyelet assembly 164 can be easily usable and mountable to multiple fishing rods having a variety of shapes and sizes and diameters.

Further, the third base component 768 and the fourth base component 772, either alone or in combination, defines a component channel 796. The second eyelet assembly 164 further includes a second eye piece 812 (see FIG. 8) defining a second ring structure 816 with a second opening 820 to provide passage to the fishing line 112 and a second strip structure 824 extending away from the second ring structure 816. Although not limited, the second opening 820 can include a circular or an oval shape. The second strip structure 824 is configured to be received within the component channel 796.

In this regard, and as shown in FIGS. 8 through 10, it will be appreciated that the component channel 796 passes through ledges 856 (respectively belonging to the third base component 768 and the fourth base component 772) and is fully formed or defined to be functional when the third base component 768 and the fourth base component 772 are moved to the second closed position. In the second closed position, the ledges 856 mate with each other, and various segments of the component channel 796 formed in said ledges 856 align with each other to define the component channel 796 in full. Effectively, when the second strip structure 824 is received within the component channel 796, as is formed in the closed position, the second strip structure 824 functions to also lock the ledges 856 with each other, in turn also locking the third base component 768 to the fourth base component 772 in the closed position.

As an example, one or more second inner surfaces defined within the ledges 856 of at least one of the third base component 768 and the fourth base component 772, defining the component channel 796, defines second retentive features (not shown, but which are similar to the first retentive features 208). The second strip structure 824 defines second engagement features 828 to establish a retentive coupling between the second eye piece 812 and at least one of the third base component 768 and the fourth base component 772 when the second strip structure 824 is received within the component channel 796 and the second engagement features 828 are engaged with the second retentive features.

In some embodiments, one or both of the second retentive features and the second engagement features 828 are formed from a resilient material, e.g., rubber, to provide sufficient compressive deformation therebetween and also acquire a positive interference fit therebetween. In some embodiments, the second ring structure 816 can be made from a smooth, a low-friction, or a friction free material such as ceramic, stainless steel, or titanium, to minimize wear on the fishing line 112. Although a single second eyelet assembly 164 is shown and described, the fishing rod assembly 100 can include multiple second eyelet assemblies coupled to and arranged on the fishing rod 108 in a spaced manner along a length of the fishing rod 108. Therefore, any reference to the number of the eyelet assemblies in the present description, i.e., the two eyelet assemblies, namely, the first eyelet assembly 160 and the second eyelet assembly 164, is purely exemplary.

During use, the first base component 168 and the second base component 172 may be slid onto the end 140 and then engaged with each other to be retentively clamped to the end 140 or to the distal section 132. In that manner, the distal section 132 and/or the end 140 is housed within the first tubular channel 176. Similarly, the third base component 768 and the fourth base component 772 may be slid onto the proximal section 136 and then engaged with each other to be retentively clamped to the proximal section 136. In that manner, the proximal section 136 is housed within the second tubular channel 776. An assembly of the first tubular channel 176 and the second tubular channel 776 onto the fishing rod 108 also ensures that the first eyelet assembly 160 and the second eyelet assembly 164 are properly aligned with the fishing rod 108.

Once the first eyelet assembly 160 and the second eyelet assembly 164 are in place or arranged in the like manner on the fishing rod 108, the first eye piece 212, configured as a tip-top guide for the fishing line 112, is attached to the first base component 168 by having the first strip structure 224 inserted into the segment channel 196. Similarly, the second eye piece 812, configured as an intermediate guide for the fishing line 112, is attached to the third base component 768 and/or to the fourth base component 772 by having the second strip structure 824 inserted into the component channel 796 defined by the ledges 856. The insertable and modular design of the first eyelet assembly 160 and the second eyelet assembly 164 allows the first eye piece 212 and the second eye piece 812 to be replaceable or adjusted as needed without disturbing the base components, thus enabling quick repairs and/or installations on field, which can be valuable in wilderness survival scenarios.

With the help of the first eyelet assembly 160 and the second eyelet assembly 164, anglers, such as angler 104, are able to replace damaged eyelet assemblies easily and thus repeatedly re-use the fishing rod assembly 100. More particularly, the eyelet system 156 is a detachable eyelet system that can be easily installed onto the fishing rod 108, or even onto natural materials, such as branches, vines, or other wilderness-found items as may be used in the absence of one or more components, such as the fishing rod 108, of the fishing rod assembly 100. The installation of the eyelet system 156 onto the fishing rod 108 can be attained without specialized tools, and thus the eyelet system 156 is well suited for a tool-free installation, which is applicable particularly in environments where conventional tools may be unavailable or absent.

The eyelet system 156 is designed to be compatible with various fishing rod sizes and types, as well as a range of natural materials, offering a universal solution for anglers and wilderness enthusiasts. The modular design of the eyelet system 156 ensures durability, ease of use, and adaptability, reducing the need for costly rod replacements or complex repairs. The replaceability offered by the eyelet system 156 enhances the functionality of both manufactured fishing rods and improvised fishing tools, providing a practical solution for recreational anglers and survivalists, especially when maintaining or creating a functional tip-top guide. The eyelet system 156 also has a compact design and can also be used as a kit, e.g., a survival kit, for wilderness enthusiasts. Varies shapes, sizes, and specification of the first eye piece 212 and the second eye piece 812 may also be contemplated, according to varied requirements on field.

The eyelet system 156, which is replaceable, can also be added to any existing survival kit for such wilderness enthusiasts, particularly those relying on fishing for food and sustenance, e.g., in remote environments or areas. In survival scenarios, a functional fishing implement with a reliable tip-top guide is often needed for procuring food. However, damaged eyelet assemblies on a fishing rod and/or the absence of one can hinder fishing and sustenance efforts. The eyelet system 156 and/or the fishing rod assembly 100 addresses this challenge by providing a compact, lightweight, and easy-to-use solution for quickly replacing one or more damaged eyelet assemblies on a fishing rod 108 and/or installing on improvised fishing implements, which may be crafted from wilderness materials, such as branches, bamboos, vines, or other sturdy natural structures. The eyelet system's tool-free installation allows users to easily secure the base components to the fishing rod's tip.

Effectively, the eyelet system 156 can be attached to fishing rods to provide smooth guidance to the fishing line 112, enabling effective casting and reeling (even with makeshift tools). The material for one or more parts of the eyelet system 156, e.g., the base components 168, 172, 768, 772, can include durable, corrosion-resistant materials, including high-grade plastics, polymers, stainless steel, aluminum, and the like materials now known or in the future developed, ensuring a relatively high degree of reliability in rugged outdoor settings, such as freshwater and wilderness settings. In some embodiments, a connection between the first eye piece 212 and the conical segment 188 (and/or also a connection between the second eye piece 812 and the assembly of the third base component 768 and the fourth base component 772) may be attained through one or more of: threadable connection, a snap-lock connection, a bayonet connection, and/or the like connections mechanisms, now known or in the future developed. Such coupling can withstand mechanical stresses during operations, e.g., during casting or reeling operations.

Also, by including the eyelet system 156 in a survival kit, wilderness enthusiasts can repair fishing rods or even create new fishing rod assemblies by using wilderness materials, such as branches, bamboos, vines, or other sturdy natural structures as the fishing rod 108 and then coupling the eyelet system 156 onto such structures, thus ensuring a reliable food source and enhancing self-sufficiency in the wild. Moreover, the eyelet system 156 can be available in various sizes and materials to accommodate different fishing line types and rod configurations, with the eyelet assemblies 160, 164 optimized for end placement on end of fishing rods and/or on ends of other substitutes, e.g., natural substitutes.

It should be understood that the foregoing description is only illustrative of the aspects of the disclosed embodiments. Various alternatives and modifications can be devised by those skilled in the art without departing from the aspects of the disclosed embodiments.

What is claimed is:

1. An eyelet system for a fishing rod of a fishing rod assembly, the eyelet system comprising:
a first eyelet assembly including a first base component and a second base component movable between a first open position and a first closed position with respect to each other, wherein in the first closed position, the first eyelet assembly is adapted to enwrap and be removably coupled to a distal section of the fishing rod, and, in the first open position, the first eyelet assembly is adapted to be separated from the distal section of the fishing rod to be replaceable with another first eyelet assembly; and
a second eyelet assembly including a third base component and a fourth base component movable between a second open position and a second closed position with respect to each other, wherein in the second closed position, the second eyelet assembly is adapted to enwrap and be removably coupled to a proximal section of the fishing rod, and, in the second open position, the second eyelet assembly is adapted to be separated from the proximal section of the fishing rod to be replaceable with another second eyelet assembly.

2. The eyelet system of claim 1, wherein the distal section defines an end of the fishing rod, and the first eyelet assembly is configured to be positioned to cover the end of the fishing rod and define an end tip of the fishing rod assembly.

3. The eyelet system of claim 1, wherein the first base component and the second base component are tubular in structure and define a first tubular channel in the first closed position, the first tubular channel being defined around and along a rod axis of the fishing rod to allow a first portion of the fishing rod to be accommodated therethrough.

4. The eyelet system of claim 3, wherein
the first tubular channel defines a tube axis configured to be aligned with the rod axis when the first eyelet assembly enwraps the distal section,
the first eyelet assembly includes a conical segment with an apex defining an end tip of the fishing rod assembly, and
the conical segment defines a segment channel with a segment axis, wherein the segment axis is in line with the tube axis.

5. The eyelet system of claim 4, wherein
the first eyelet assembly further includes a first eye piece defining a first ring structure with a first opening to provide passage to the fishing reel and a first strip structure extending away from the first ring structure, and
the first strip structure configured to be received within the segment channel of the conical segment.

6. The eyelet system of claim 5, wherein a first inner surface of the conical segment defining the segment channel defines first retentive features and the first strip structure defines first engagement features to establish a retentive coupling between the first eye piece and the conical segment when the first strip structure is received within the segment channel.

7. The eyelet system of claim 4, wherein the conical segment is integrally formed with the first base component.

8. The eyelet system of claim 1, wherein the first base component and the second base component are coupled to each other at a first hinge defining a first swivel axis such that the first base component and the second base component swivel with respect to each other about the first swivel axis when moving between the first open position and the first closed position.

9. The eyelet system of claim 8, wherein the first swivel axis is parallel to a rod axis of the fishing rod.

10. The eyelet system of claim 1, wherein the first base component and the second base component correspondingly define first teeth and second teeth to correspondingly engage with the distal section of the fishing rod.

11. The eyelet system of claim 1, wherein the third base component and the fourth first base component are tubular in structure and define a second tubular channel in the second closed position, the second tubular channel being defined around and along a rod axis of the fishing rod to allow a second portion of the fishing rod to be accommodated therethrough.

12. The eyelet system of claim 1, wherein the third base component and the fourth base component are coupled to each other at a second hinge defining a second swivel axis such that the third base component and the fourth base component swivel with respect to each other about the second swivel axis when moving between the second open position and the second closed position.

13. The eyelet system of claim 12, wherein the second swivel axis is parallel to a rod axis of the fishing rod.

14. The eyelet system of claim 1, wherein the third base component and the fourth base component correspondingly define third teeth and fourth teeth to correspondingly engage with the proximal section of the fishing rod.

15. The eyelet system of claim 1, wherein
the third base component and the fourth base component, either alone or in combination, defines a component channel, the second eyelet assembly further including a second eye piece defining a second ring structure with a second opening to provide passage to the fishing reel and a second strip structure extending away from the second ring structure, the second strip structure configured to be received within the component channel, and
a second inner surface of at least one of the third base component and the fourth base component defining the component channel defines second retentive features, the second strip structure defines second engagement features to establish a retentive coupling between the second eye piece and at least one of the third base component and the fourth base component when the second strip structure is received within the component channel.

16. A fishing rod assembly, comprising:
a fishing rod;
a fishing reel configured to wind and release a fishing line;
a plurality of eyelet assemblies couplable with the fishing rod in a spaced manner along a length of the fishing rod, each eyelet assembly of the plurality of eyelet assemblies configured to receive and guide the fishing line extending from the fishing reel, each eyelet assembly of the plurality of eyelet assemblies including:
a pair of base components adapted to be selectively movable between an open position and a closed position with respect to each other, wherein, in the closed position, each eyelet assembly enwraps and is coupled to a corresponding section of the fishing rod, and, in the open position, each eyelet assembly is configured to be separated from the corresponding section of the fishing rod to be replaceable with another eyelet assembly.

17. The fishing rod assembly of claim 16, wherein each base component of the pair of base components is at least partially tubular in structure, the pair of base components defining a tubular channel in the closed position, the tubular channel being defined around and along a rod axis of the fishing rod to allow a portion of the fishing rod to be accommodated therethrough.

18. The fishing rod assembly of claim 16, wherein each eyelet assembly includes an eye piece defining a ring structure with an opening to provide passage to the fishing reel and a strip structure extending away from the ring structure, the strip structure configured to be received within a segment channel defined by at least one base component of the pair of base components.

19. The fishing rod assembly of claim 16, wherein the pair of base components are coupled to each other at a hinge defining a swivel axis such that the pair of base components swivel with respect to each other about the swivel axis when moving between the open position and the closed position, wherein the swivel axis is parallel to a rod axis of the fishing rod.

20. The fishing rod assembly of claim 16, wherein each base component of the pair of base components define teeth to engage with the corresponding section of the fishing rod.
